(19) United States
(12) Patent Application Publication
(10) Pub. No.: US 2001/0046075 A1
(43) Pub. Date: Nov. 29, 2001

(54) Optical coupler monitoring system

(76) Inventor: Tomoaki Kouyama, Tokyo (JP)

Correspondence Address: McGuire Woods, 1750 Tysons Boulevard, Suite 1800, Tysons Corner, McLean, VA, 22102-4215, US

(21) Appl. No.: 09/863,435

(22) Filed: May 24, 2001

(30) Foreign Application Priority Data
May 26, 2000 (JP) 156632/2000

(51) Int. Cl. H04B 10/08; H04J 14/02

(52) U.S. Cl. 359/110; 359/125

(57) ABSTRACT

An optical coupler monitoring system comprises a station side monitoring unit 4, which is connected via an optical transmission line to the station side of an optical coupler 3 and outputs a monitoring optical signal of wavelength 2 different from wavelength 1 (i.e., wavelength of down communication service optical signal) and also from wavelength 2 (i.e., wavelength of up communication service optical signal), and a subscriber side monitoring unit 5, which is connected via an optical transmission line to the subscriber side of the optical coupler and has a filtering means for passing optical signal of wavelength 2 and removing optical signal of wavelength 1. The subscriber side monitoring unit 5 checks the normality of the optical coupler by processing optical signal of wavelength 4 outputted from a station side monitoring unit 4. All subscriber terminals 2 each have a filtering means for passing optical signal of wavelength 1 and remove optical signal of wavelength 2. Service communication thus can be guaranteed, which is free from adverse effects of monitoring optical signal.

### BACKGROUND OF THE INVENTION

This application claims benefit of Japanese Patent Application No. 2000-156632 filed on May 26, 2000, the contents of which are incorporated by the reference.

The present invention relates to an optical coupler monitoring system for a passive optical network communication system.

An optical coupler is used for organizing a passive optical network (PON) communication system such that it connects a plurality of subscriber terminals via an optical transmission line to a station side terminal. FIG. 8 is a view showing a typical example of the PON communication system. In this communication system, an optical coupler 8 connects one station side terminal 6 and N subscriber terminals 7 as branches in a ratio of 1:N.

In the usual communication service, a wavelength of 1.31 μm is used for up signal transmission from the subscriber terminals 7 to the station side terminal 6, while a wavelength of 1.55 μm is used for down signal transmission from the station side terminal 6 to the subscriber terminals 7.

In the above PON communication system, the optical coupler serves to couple an optical signal having a wavelength of 1.55 μm as down signal to N branches. However, since the wavelength of 1.55 μm is used during the communication service operation, it is impossible to monitor the optical coupler itself.

### SUMMARY OF THE INVENTION

An object of the present invention is to provide an optical coupler monitoring system, which permits monitoring of the wavelength coupling function of the optical coupler even during the communication service operation.

To solve the above problem, it is a feature of the present invention to monitor the quality of the optical coupler itself by using a wavelength which is not used for communication.

The optical coupler monitoring system according to a first aspect of the present invention comprises a first and a second monitoring units. The first monitoring unit is connected via an optical transmission line to the station side of an optical coupler, and outputs monitoring optical signal of a third wavelength different from a first and a second wavelengths for communication service. The second monitoring unit is connected via an optical transmission line to the subscriber side of the optical coupler, and has a filtering means for passing optical signal of the third wavelength and removing optical signal of the first wavelength.

The second monitoring unit further has a function of checking the normality of the optical coupler by receiving optical signal of the third wavelength outputted from the first monitoring unit and processing the received optical signal. All subscriber terminals each have a filtering means for passing optical signal of the first wavelength and removing optical signal of the second wavelength.

When communication service optical signal of the first wavelength and optical signal of the third wavelength are outputted from the station side terminal and the first monitoring unit, the optical coupler couples these two signals to all the subscriber terminals and the second monitoring unit. Each subscriber terminal, however, receives the sole communication service optical signal of the first wavelength by removing the monitoring optical signal of the third wavelength with the filtering means. On the other hand, the second monitoring unit receives the sole monitoring optical signal by removing the communication service optical signal of the first wavelength with the filtering means.

The second monitoring unit thus checks the quality of the optical filter in the down direction by processing the received monitoring optical signal.

Since all the subscriber terminals each have the filtering means for passing optical signal of the first wavelength and removing optical signal of the third wavelength, the station side terminal and the subscriber terminals can obtain normal communication service without being disturbed by monitoring optical signal.

The optical coupler monitoring system according to a second aspect of the present invention, comprises a second monitoring unit connected via an optical transmission line to the subscriber side of the optical coupler and outputting monitoring optical signal of a fourth wavelength different from the first and second wavelengths, and a first monitoring unit connected via an optical transmission line to the station side of the optical coupler and including a filter means, which passes optical signal of the fourth wavelength and removes optical signal of the second wavelength, the first monitoring means being operative to check the normality of the coupler by processing optical signal of the fourth wavelength outputted from the second monitoring unit, the station side terminal including a filtering means for passing optical signal of the second wavelength and removing optical signal of the fourth wavelength.

The optical coupler monitoring system according to the second aspect of the present invention can monitor the quality of the optical coupler in the up direction by the operation as in the optical coupler monitoring system according to the first aspect of the present invention.

Provided the first and fourth wavelengths are different, it is possible to monitor the quality of the optical coupler in both the up and down directions by combining the first and second optical coupler monitoring systems.

Other objects and features will be clarified from the following description with reference to attached drawings.

### BRIEF DESCRIPTION OF THE DRAWINGS

FIG. 1 is a view showing the configuration of a first embodiment of the optical coupler monitoring system according to the present invention;

FIG. 2 is a flowchart for describing the processing of signal of wavelength 1 in the optical coupler monitoring system shown in FIG. 1;

FIG. 3 is a flowchart for describing the processing of the monitoring optical signal of wavelength 2 in the optical coupler monitoring system shown in FIG. 1;

FIG. 4 is a block diagram showing the configuration of the second embodiment of the present invention;

FIG. 5 is a flowchart for describing the processing of signal of wavelength 3 in the optical coupler monitoring system shown in FIG. 4;

FIG. 6 is a flow chart showing the processing of signal of wavelength 4;

FIG. 7 is a block diagram showing the configuration of a third embodiment of the present invention; and

FIG. 8 is a view showing a typical example of the PON communication system.

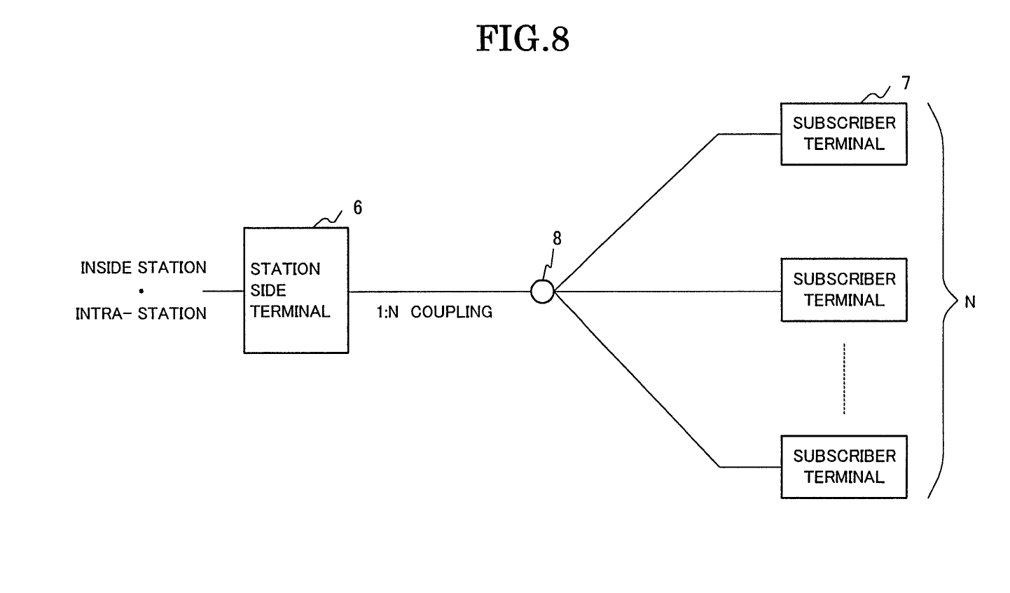

### PREFERRED EMBODIMENTS OF THE INVENTION

Preferred embodiments of the present invention will now be described with reference to the drawings.

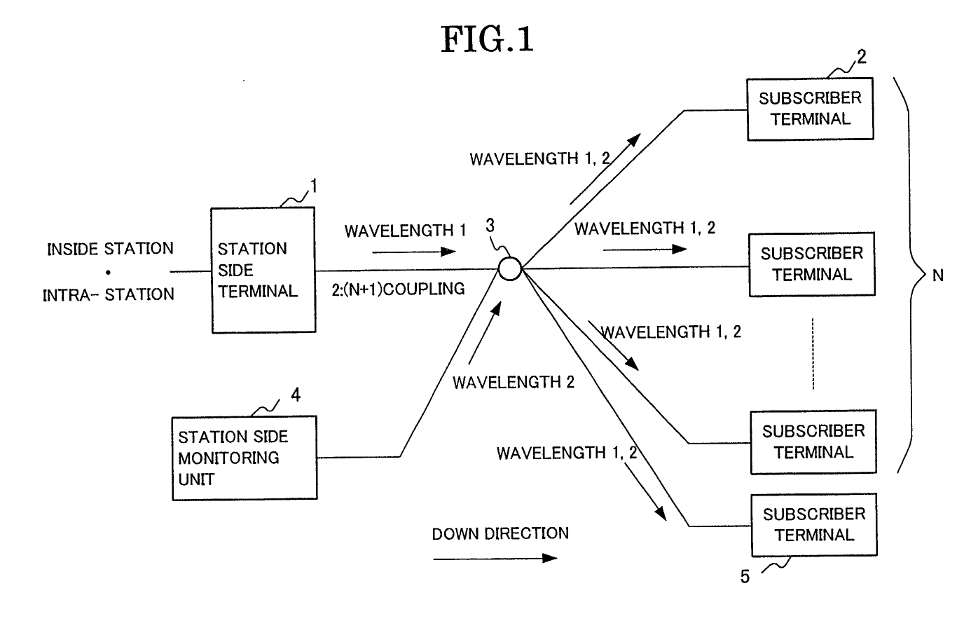

FIG. 1 is a view showing the configuration of a first embodiment of the optical coupler monitoring system according to the present invention.

In this embodiment of optical coupler monitoring system, an optical coupler 3 connects one station side terminal 1 for outputting down service communication optical signals of wavelength 1 and a station side monitoring unit 4 for outputting a down monitoring optical signal of wavelength 1 to N subscriber terminals 2 for receiving signal of wavelength 1 and a subscriber side monitoring unit 5 for receiving signal of wavelength 2 in a ratio of 2:(N+1).

The optical coupler 3 couples signal of wavelength 1 outputted from the station side terminal 1 and also signal of wavelength 2 outputted from the station side monitoring unit 4 to the subscriber terminals 2 and the subscriber side monitoring unit 5. The subscriber side monitoring unit 5 has a function of checking for abnormality of the optical coupler 3 by processing the monitoring signal received via the optical coupler 3.

For monitoring the optical coupler 3 a signal route is provided, on which the monitoring signal of wavelength 2, different from wavelength 1 used for the communication service, is transmitted form the station side monitoring unit 4 and coupled via the coupler 3 to the subscriber side monitoring unit 5. As is well known in the art, the down and up optical signal wavelengths 1 and 2 for the communication service are different from each other.

The operation of this embodiment will now be described.

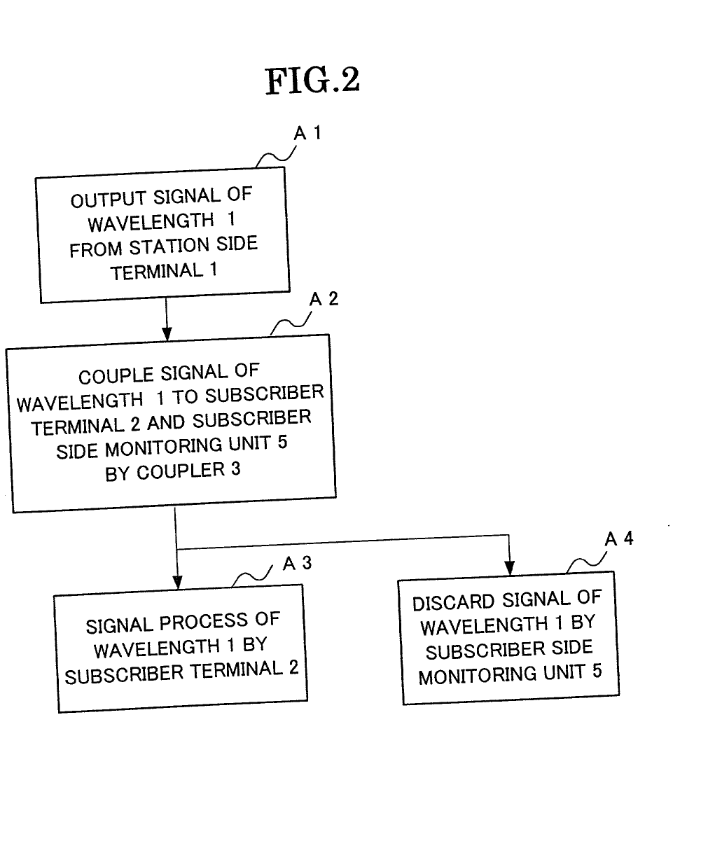

FIG. 2 is a flowchart for describing the processing of signal of wavelength 1 in the optical coupler monitoring system shown in FIG. 1.

Referring to the Figure, the station side terminal 1 outputs signal of wavelength 1 (step A1). The optical coupler 2 couples this signal to the N subscriber terminals 2 and the subscriber side monitoring unit 5 (step A2). Each subscriber terminal 2 has a filtering function to receive the sole signal of wavelength 1, and it thus receives and processes signal of wavelength 1 so as to output the processed signal to the subscriber (step A3). The subscriber side monitoring unit 5 has a filtering function not to receive (i.e., remove) signal of wavelength 1, and it thus discards signal of wavelength 1 when it receives this signal (step A4).

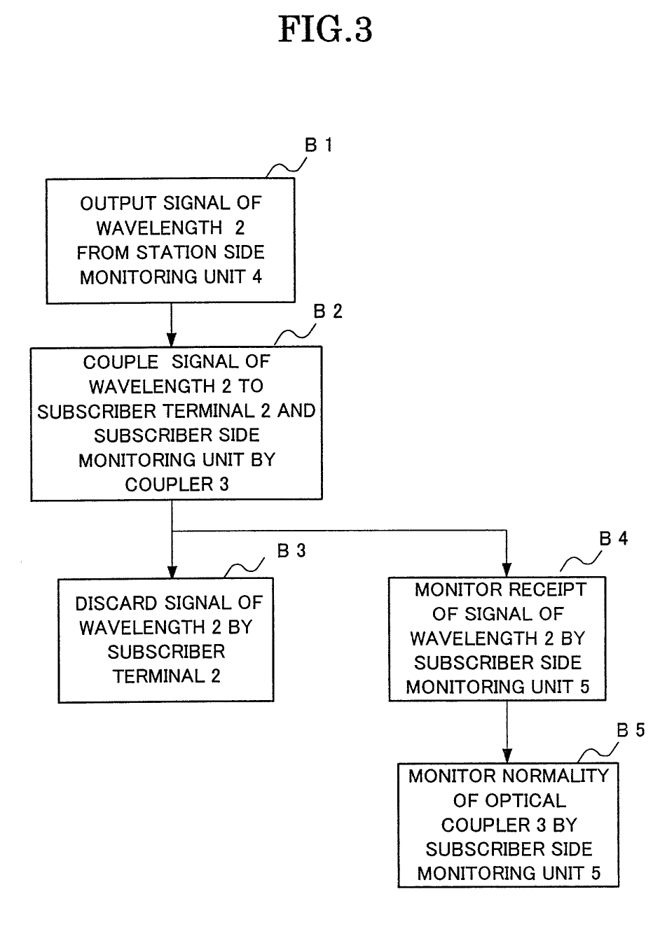

FIG. 3 is a flow chart for describing the processing of the monitoring optical signal of wavelength 2 in the optical coupler monitoring system shown in FIG. 1.

The station side monitoring unit 4 outputs signal of wavelength 2 as monitoring signal for monitoring the optical coupler 3 (step B1). The optical coupler 3 couples this signal to the N subscriber terminals 2 and the subscriber side monitoring unit 5 (step B2). Each subscriber terminal 2 has a function not to receive (i.e., remove) signal of wavelength 2, and it thus discards signal of wavelength 2 (step B3).

The subscriber side monitoring unit 5 has a filtering function to remove signal of wavelength 1 while receiving signal of wavelength 2. When the unit 5 receives signal of wavelength 2, it performs a test on the monitoring signal outputted from the station side monitoring unit 4 (step B4). The unit 5 thus monitors the normality of the optical coupler 3 by judging the result of the test to be “OK” or “NG”.

A second embodiment of the present invention will now be described.

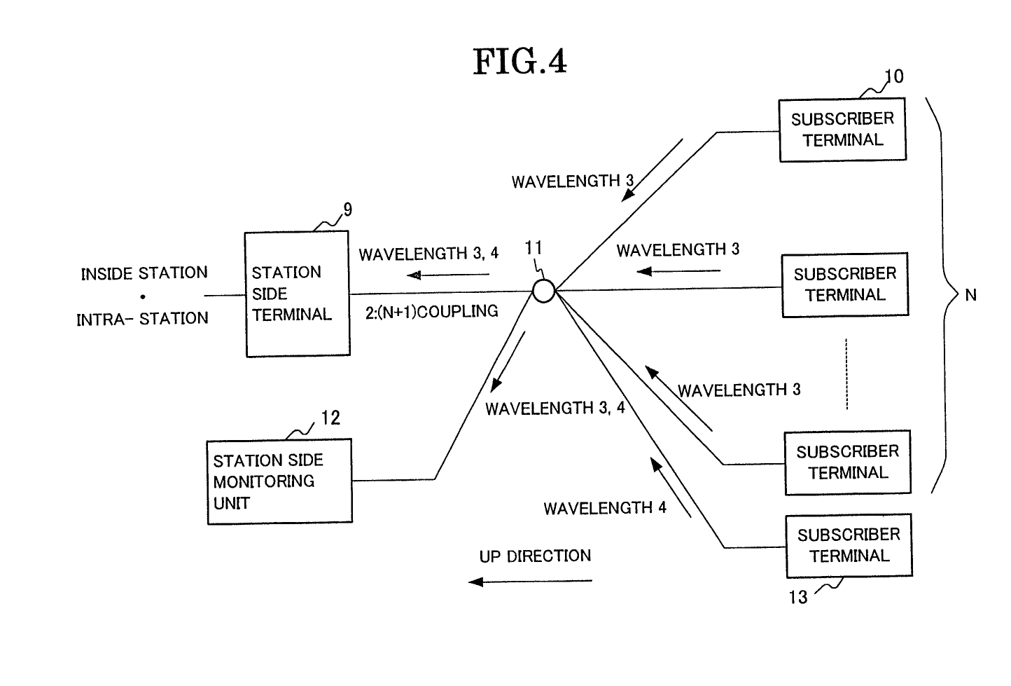

FIG. 4 is a block diagram showing the configuration of the second embodiment of the present invention.

In this embodiment of the optical coupler monitoring system, an optical coupler 11 couples one station side terminal 9 for receiving signal of wavelength 3 and a station side monitoring unit 12 for receiving signal of wavelength 4 to N subscriber terminals 10 for outputting the signal of wavelength 3 as up service communication optical signal and a subscriber side monitoring unit 13 for outputting signal of wavelength 4 as up monitoring optical signal of wavelength 4 in a ratio of 2:(N+1). The station side terminal 9 has a filtering function to pass optical signal of wavelength 3 and remove optical signal of wavelength 4. The station side monitoring unit 12 has a filtering function to pass optical signal of wavelength 4 and remove optical signal of wavelength 3. The unit 12 also has a function, provided when optical signal of wavelength 4 is received via the optical coupler, to check for abnormality of the optical coupler 3 by processing the received signal.

The optical coupler 11 couples optical signal of wavelength 3 outputted from each subscriber terminal 10 and optical signal of wavelength 4 outputted from the subscriber side monitoring unit 13 to the station side terminal 9 and the station side monitoring unit 12.

As shown, for monitoring the optical coupler 11, a signal route is provided, on which the monitoring signal of wavelength 4, different from wavelength 3 used for the communication service, is transmitted from the subscriber side monitoring unit 13 and coupled via the optical coupler 11 to the station side monitoring unit 12. The wavelengths 3 and 4 are different from each other.

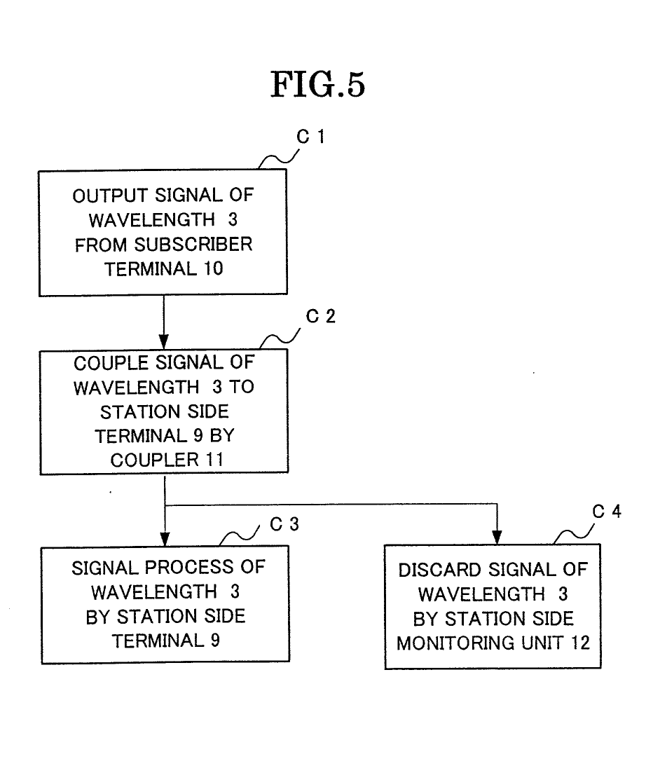

The processing of signal of wavelength 3 in the optical coupler monitoring system shown in FIG. 4 will now be described with reference to FIG. 5 showing a flow chart showing the processing of signal of wavelength 3.

Each subscriber terminal 10 outputs signal of wavelength 3 (step C1). The optical coupler 11 couples this signal to the station side terminal 9 and the station side monitoring unit 12 (step C2). The terminal 9 has a filtering function to pass optical signal of wavelength 3 and remove optical signal of wavelength 4. The terminal 9 thus processes the signal of wavelength 3 and outputs the processed signal to the station side (step C3). The station side monitoring unit 12 has a filtering function to passes optical signal of wavelength 4 and remove signal of wavelength 3, and it thus discards signal of wavelength 3 when it receives this signal (step C4).

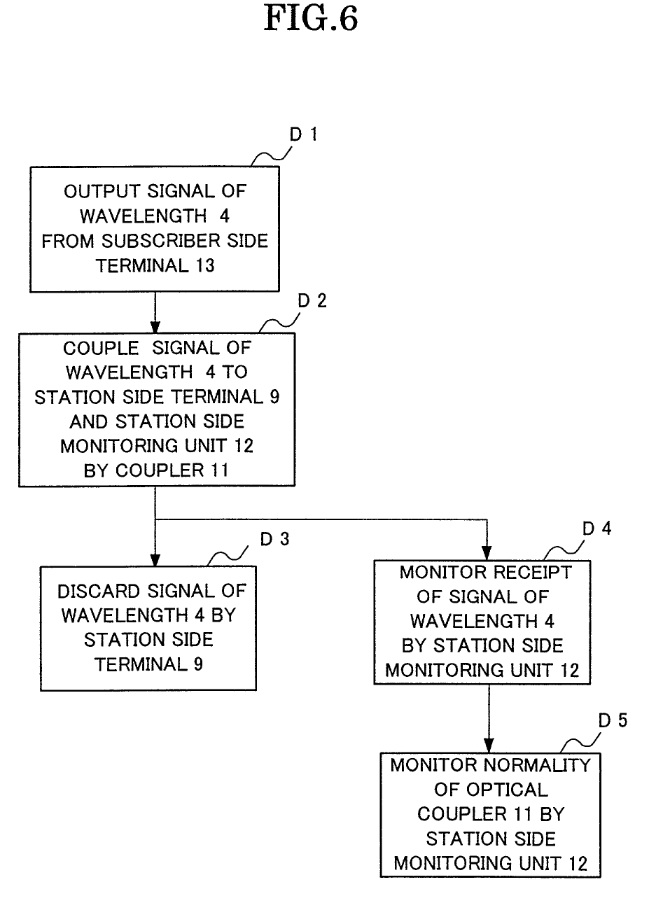

The processing of signal of wavelength 4 will now be described with reference to FIG. 6 showing a flow chart showing the processing of signal of wavelength 4.

The subscriber side monitoring unit 13 outputs optical signal of wavelength 4 as monitoring optical signal for monitoring the optical coupler 11 (step D1). The optical coupler 11 couples this signal to the station side terminal 9 and the station side monitoring unit 12 (step D2). The station side unit 9 discards signal of wavelength 4 with the filtering function noted above (step D3).

When the station side monitoring unit 12 receives signal of wavelength 4, it performs a test on this signal (step D4). The unit 12 thus monitors normality of the optical coupler 11 by judging the result of the test to be “OK” or “NG” (step D5).

The above first and second embodiments are examples of monitoring with down and up monitoring optical signals, respectively; that is, they are optical coupler monitoring systems, in which the quality of the optical coupler is monitored with respect to the coupling in the down and up directions, respectively.

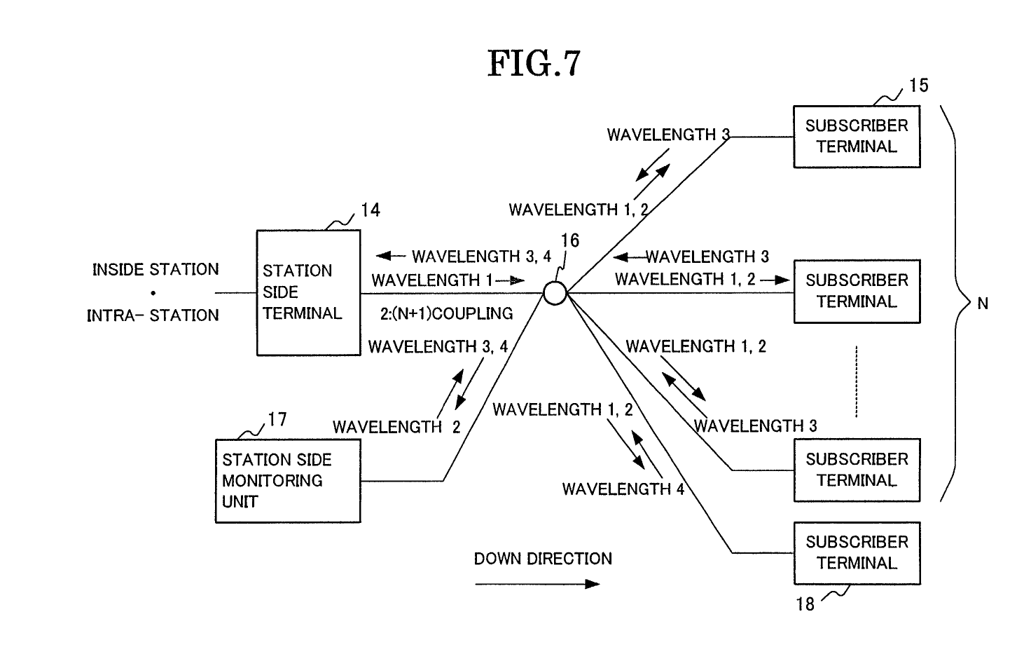

FIG. 7 is a block diagram showing the configuration of a third embodiment of the present invention.

This embodiment is a bilateral optical coupler monitoring system obtained by combining the first and second embodiments. This combination can be realized so long as the wavelength 2 of the down monitoring optical signal (see FIG. 1) and the wavelength 4 of the up monitoring optical signal (see FIG. 4) are different from each other.

The station side terminal 14 outputs optical signal of wavelength 1 for communication service, and station side monitoring unit 17 outputs monitoring optical signal of wavelength 2. The optical coupler 16 couples the signals of wavelengths 1 and 2 to N subscriber terminals 15 and subscriber side monitoring unit 18. The N subscriber terminals 15 each output optical signal of wavelength 3 for communication service, and the subscriber side monitoring unit 8 outputs monitoring optical signal of wavelength 4. The optical coupler 16 combines these signals, and couples the resultant signal to the station side terminal 14 and the station side monitoring unit 17.

To this end, the station side terminal 14, the subscriber terminals 15, the station side monitoring unit 17 and the subscriber side monitoring unit 18 have filters, which fulfill respective functions. Specifically, the filter in the station side terminal 14 passes optical signal of wavelength 1 and removes optical signal of wavelength 2. The filter in each subscriber unit 15 passes optical signal of wavelength 4 and removes optical signal of wavelength 3. The filter in the station side monitoring unit 18 passes optical signal of wavelength 4 and removes optical signal of wavelength 3. The filter in the subscriber side monitoring unit 18 passes optical signal of wavelength 2 and removes optical signal of wavelength 1.

Thus, the station side terminal 14 and the subscriber terminals 15 can realize service communication with one another with the down and up optical signals of wavelengths 1 and 3, respectively. Meanwhile, the station side monitoring unit 17 and the subscriber side monitoring unit 18 receive and process up and down optical signals of wavelengths 4 and 2, respectively, and check normality for the functions of the optical coupler in the up and down directions. In this way, these units 17 and 18 monitor the optical coupler.

In the above three embodiments, the station side terminal, the station side monitoring unit and the subscriber side monitoring unit can be installed in a single room. The above embodiments of the optical coupler monitoring system can of course be provided in a passive optical network communication system.

As has been described in the foregoing, the present invention has the following effects. Since the optical coupler can be monitored without adversely affecting the communication service by using a wavelength not used therefor, it is possible to monitor the normality of the optical coupler even while the communication service is in force. Since the optical coupler monitoring system according to the present invention can be carried out in the building of the station, no maintenance member need visit subscriber's houses. It is thus possible to save time and cost of the maintenance of the optical coupler.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. An optical coupler monitoring system for monitoring the quality of an optical filter, which couples a communication service optical signal of a first wavelength transmitted from a station side terminal via an optical transmission line to a given number of subscriber terminals and also couples a communication service optical signal of a second wavelength transmitted from the subscriber terminals via an optical transmission line to the station side terminal, the optical coupler monitoring system comprising:
a first monitoring unit connected via an optical transmission line to the station side of the optical coupler and outputting a monitoring optical signal of a third wavelength different from the first and second wavelengths; and
a second monitoring unit connected via an optical transmission line to the subscriber side of the optical coupler and including a filtering means, which passes optical signal of the third wavelength and removes optical signal of the first wavelength, the second monitoring unit being operative to check the normality of the optical coupler by receiving optical signal of the third wavelength outputted from the first monitoring unit via the optical coupler and processing the received optical signal;
all the subscribers each passing optical signal of the first wavelength and removing optical signal of the third wavelength.

2. The optical coupler monitoring system according to claim 1, wherein the second monitoring unit has a function of outputting a monitoring optical signal of a fourth wavelength different from the first to third wavelengths, the station side terminal includes a filtering means for passing optical signal of a second wavelength and removes optical signal of the fourth wavelength, the first monitoring unit includes a filtering means for passing optical signal of the fourth wavelength and removing optical signal of the second wavelength and further has a function of checking the normality of the optical coupler by receiving optical signal of the fourth wavelength outputted from the second monitoring unit via the optical coupler and processing the received optical signal.

3. The optical coupler monitoring system according to claim 2, wherein the first and second monitoring units are installed in the same place as the station side terminal.

4. A passive optical network communication system, which includes the optical coupler monitoring system according to one of claims 1 and 2.

5. An optical coupler monitoring system for monitoring the quality of an optical filter, which couples a communication service optical signal of a first wavelength transmitted from a station side terminal via an optical transmission line to a given number of subscriber terminals and also couples a communication service optical signal of a second wavelength transmitted from the subscriber terminals via an optical transmission line to the station side terminal, the optical coupler monitoring system comprising:
a second monitoring unit connected via an optical transmission line to the subscriber side of the optical coupler and outputting monitoring optical signal of a third wavelength different from the first and second wavelengths; and
first monitoring unit connected via an optical transmission line to the station side of the optical coupler and having a filtering means, which passes optical signal of the third wavelength and removes optical signal of the second wavelength, the first monitoring unit being operative to check the normality of the optical coupler by receiving optical signal of the third wavelength outputted from the second monitoring unit via the optical coupler and processing the received optical signal;
the station side terminal including a filtering means for passing optical signal; of the second wavelength and removing optical signal of the third wavelength.

6. A passive optical network communication system including the optical coupler monitoring system according to claim 5.
